(19) United States
(12) Patent Application Publication
(10) Pub. No.: US 2015/0378722 A1
(43) Pub. Date: Dec. 31, 2015

(54) ENHANCED COMPLIANCE VERIFICATION SYSTEM

(71) Applicant: Quantum Fuel Systems Technologies Worldwide, Inc., Lake Forest, CA (US)

(72) Inventor: Maria Eugenia Zuniga-Hernandez, Foothills Ranch, CA (US)

(73) Assignee: Quantum Fuel Systems Technologies Worldwide, Inc.

(21) Appl. No.: 14/845,869

(22) Filed: Sep. 4, 2015

Related U.S. Application Data
(63) Continuation of application No. PCT/US2015/032065, filed on May 21, 2015.
(60) Provisional application No. 62/001,514, filed on May 21, 2014.

(51) Int. Cl. G06F 9/44; G06Q 10/06; H04L 29/06

(52) U.S. Cl. CPC G06F 8/70; H04L 65/403; G06Q 10/0635

(57) ABSTRACT

Methods and systems for developing and deploying software applications in a computing environment hosted by multi-user computing services platforms. Web-based user interfaces providing one or more options for accessing a software development project hosted by multi-user computing services platforms for presentation to users. Multi-user computing and network services platforms configured to receive, via the user interface, inputs to software development projects, which may include change requests or work items.

### CROSS-REFERENCE TO RELATED APPLICATIONS

This patent application is a Continuation of International patent application PCT/US2015/032065 filed May 21, 2015, which claims priority to Provisional patent application 62/001,514 filed May 21, 2014, the disclosures of which are incorporated by reference in their entirety.

### BACKGROUND

Many software development projects must comply with multiple requirements. For example, a software development project may need to comply with an industry standard such as ISO 26262, a functional safety standard. Another example of a standard is ISO/IEC 15504, also known as SPICE (Software Process Improvement and Capability Determination), which is a set of standards for computer software development. Additional processes may also be implemented, such as Agile Scrum.

### DISCLOSURE

Disclosed herein are methods and systems for developing and deploying software applications in a computing environment hosted by a multi-user computing services platform. In some embodiments, a web-based user interface providing one or more options for accessing a software development project hosted by the multi-user computing services platform is presented to a developer user. The multi-user computing and network services platform receives, via the user interface, inputs to the software development project. The inputs may include a change request or a work item.

In response to receiving the inputs, data available within the multi-user computing services platform is accessed and used to verify compliance of the change request or the work item to applicable standards and development processes. A plurality of requests from the various users and developers may be processed.

The present disclosure provides aspects of computer-implemented methods for developing and deploying software applications comprising presenting, to a developer user of a multi-user computing platform, a user interface providing one or more options for accessing a software development project hosted by the multi-user computing services platform; receiving, by the multi-user computing services platform via the user interface, inputs to the software development project, wherein the inputs comprise at least one of a change request and a work item; in response to receiving the inputs, accessing data associated with at least one industry standard and at least one software development process; automatically generating, based on the data, one or more user actions consistent with conformance to the at least one industry standard and at least one software development process; and providing, by the multi-user computing services platform, a user interface indicative of the one or more user actions.

The present disclosure provides aspects of systems configured to develop and deploy software applications hosted by a multi-user computing services platform comprising at least one memory having stored therein computer instructions that, upon execution by one or more processors of the system, cause the system to (i) present, to a developer user of a multi-user computing platform, a user interface providing one or more options for accessing a software development project hosted by the multi-user computing services platform, (ii) receive, by the multi-user computing services platform via the user interface, inputs to the software development project, wherein the inputs comprise at least one of a change request and a work item, (iii) in response to receiving the inputs, access data associated with at least one industry standard and at least one software development process, (iv) automatically generate, based on the data, one or more user actions consistent with conformance to the at least one industry standard and at least one software development process, and (v) provide, by the multi-user computing services platform, a user interface indicative of the one or more user actions. The present disclosure provides aspects of such systems, wherein the at least one memory further comprises computer instructions that, upon execution by one or more processors of the system, cause the system to implement a developer editor configured to present a web-based user interface and a development environment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. All reference numerals, designators, and call-outs in the figures are hereby incorporated by this reference as fully set forth herein. The failure to number an element in a figure is not intended to waive any rights, and unnumbered references may also be identified by alpha characters in the figures.

FIG. 1 illustrates a high-level system diagram in accordance with some aspects of the disclosure;

FIG. 2 illustrates a functional block diagram depicting an application development environment in accordance with some aspects of the disclosure;

FIG. 3 illustrates aspects of a software development process in accordance with some aspects of the disclosure;

FIG. 4 illustrates aspects of a scrum construction life cycle in accordance with some aspects of the disclosure;

FIG. 5 illustrates aspects of a software development workflow in accordance with some aspects of the disclosure;

FIG. 6 illustrates aspects of a user interface in accordance with some aspects of the disclosure;

FIG. 7 illustrates aspects of a change request workflow for a developer user in accordance with some aspects of the disclosure;

FIG. 8 illustrates aspects of a change request workflow for a supervisor or approver in accordance with some aspects of the disclosure;

FIG. 9 illustrates aspects of a user interface showing creation of a work item or a sub-work item in accordance with some aspects of the disclosure;

FIG. 10 illustrates aspects of a user interface showing manual creation of link associations in accordance with some aspects of the disclosure;

FIG. 11 illustrates aspects of a flow for a work item or a change request in accordance with some aspects of the disclosure;

FIG. 12 illustrates aspects of a user interface showing creation of a sub work item in accordance with some aspects of the disclosure;

FIG. 13 illustrates aspects of a requirements workflow in accordance with some aspects of the disclosure;

FIG. 14 illustrates aspects of a test case work flow in accordance with some aspects of the disclosure;

FIG. 15 illustrates aspects of a coding, calibration, defect and supporting task work flow in accordance with some aspects of the disclosure;

FIG. 16 illustrates a flowchart depicting aspects of a method for providing a software development environment in accordance with some aspects of the disclosure;

FIG. 17 illustrates aspects of an operational procedure for developing and deploying software applications in accordance with some aspects of the disclosure; and

FIG. 18 illustrates aspects of computing devices and networks in accordance with some aspects of the disclosure.

### DETAILED DESCRIPTION OF ILLUSTRATIVE EMBODIMENTS

Aspects of the exemplary implementations of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which may further be defined by appended claims and applicable law.

Software development is a complex and labor intensive activity that requires rigorous processes to ensure compliance to requirements. As the scale of software development increases and because software development teams need to coordinate activities related to software projects, some parts of the software development process may be performed in a network environment to enable the use of a network of computational resources to process and coordinate the activities of multiple developers and teams. Software development solutions that focus on a typical integrated development environment provide limited direct support for coordinating software development activity. As a result, much of the software development work is implemented in an ad hoc manner with each team recreating its own process, and tools, which can lead to inefficiencies, security issues, and errors. For example, the process of bringing together various components of a software application project developed on different computers or on the same computer but at different times also can be error prone and require an inordinate amount of effort by the developers. Correct builds require complex build environments to be replicated as closely as possible on many different desktops.

Many software development projects are large and complex and can include a large number of interconnected devices with a mix of various types of data flowing through both virtual and physical components. Computing devices, such as servers and routers, may have complex interactions, and behaviors in one area can affect the performance of the entire computing environment.

Furthermore, many software development projects require compliance to one or more sets of requirements such as a software development process. For example, one process is the ISO/IEC 15504, also referred to as SPICE (Software Process Improvement and Capability Determination), which is a set of technical standards for the software development process. Another set of requirements is Agile Scrum which is an iterative and incremental agile software development framework for managing software projects and product or application development. Software development projects may also require compliance to one or more industry standards such as ISO 26262 which is a functional safety standard. A software development project may require compliance to any number of such standards and processes. Such standards and processes can be complex and verification of compliance may be difficult and require significant effort. This effort can grow significantly when multiple standards and processes are involved.

Thus, there is a need for an improved software development system where verification of software development activities to one or more standards and processes can be provided in an efficient and secure manner. While the examples provided herein are described in the context of software development in an automotive context, the same concerns exist for any development in an industry where a software product is developed.

To address these issues, the present disclosure describes a development environment where the process of developing and deploying a software application may be provided by an integrated development and deployment environment that is configured to facilitate the verification of compliance to one or more standards and processes.

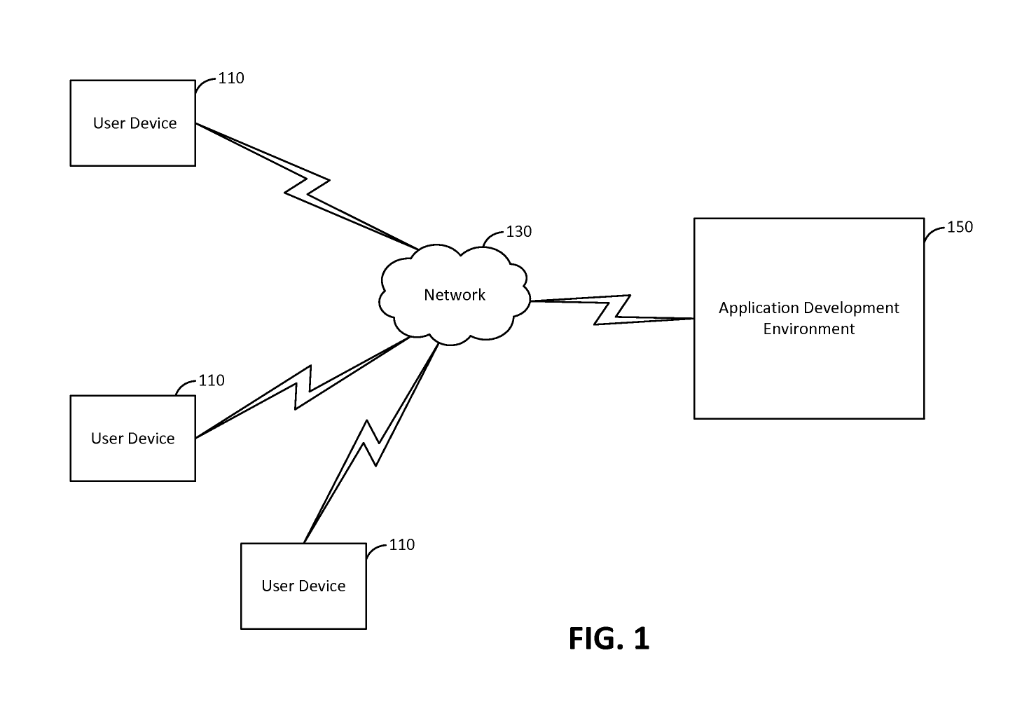

In at least some embodiments, software applications may be developed and deployed in a computing environment hosted by a multi-user computing and network services platform. Turning now to FIG. 1, a high-level system diagram of a system 100 is illustrated where one or more aspects of the disclosure may be implemented. System 100 may comprise one or more user devices 110 for viewing, editing, or otherwise accessing content developed via components of system 100, such as, for example, source code files and documentation. The user devices 110 may include a computer. The user devices 110 may communicate via one or more communication links with an application development environment 150 over a network 130. The network 130 may include a computer. Each developer or user may create different types of content if desired. The user devices 110 may be configured to reproduce the content in the form of displayed images and text. As used herein, users of the system may be referred to as users, developers, or developer users.

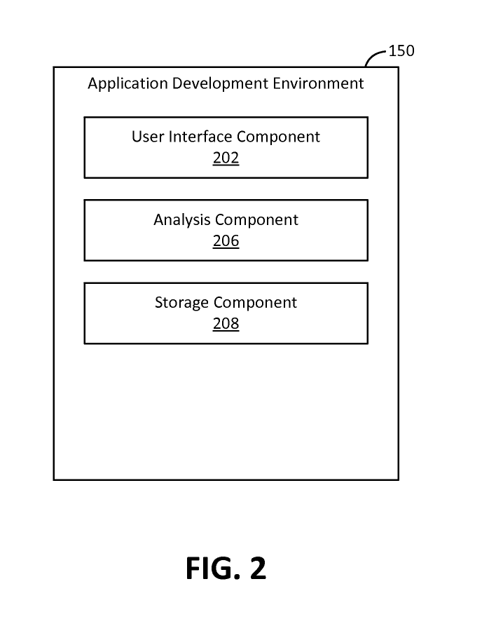

FIG. 2 is a functional block diagram depicting application development environment 150 in greater detail. In some aspects, one or more of the components depicted in FIG. 2 may be cloud-based. Application development environment 150 may include a user interface component 202. User interface component 202 may be configured to present one or more user interfaces enabling users, such as developers, to create content, view content, interact with content, and/or other actions.

User interface component 202 may also include a developer component configured to provide an editing interface control, which may facilitate the construction of application data, logic, or any other editing related task. In some aspects, the developer component of the user interface component 202 may provide a default editor that provides a core set of action objects that can be extended, modified, and used together to define a project. For example, the developer component of the user interface component may provide an interface for developer devices 120 to create content. For example, a developer component of the user interface component 202 may be configured to present options for uploading content to be edited and to add one or more components to the content.

An analysis component 206 may also be provided for analyzing change requests and work items for compliance to a standard or development process. A storage component 208 may also be provided for storing content both during the development process and after the development is complete.

In one example of an application development environment 150, application development environment 300 may include a server application cluster and set of development modules that may provide a centralized project environment where applications can be constructed/created/programmed/edited. Application development environment 300 may include server applications which may include, for example, a cluster of application images running as instances on a virtualized infrastructure. The instances may utilize default and developer specific configuration data which may be stored on digital media available to the applications.

Environment 300 may include development tools that, in some embodiments, may include a set of software libraries and tools that a software developer may use to construct additional configuration data that defines an application as well as additional tools that might be configured to allow editing of the application's data.

In one embodiment, application development environment 300 may include an editor, which may be, for example, an editing interface configured to facilitate the construction of application data, logic, and other programming or editing related tasks.

In one embodiment, application development environment 300 may include application input/output data and source code which may comprise developer unique data and source code constructed from libraries provided by the development tools.

In one embodiment, application development environment 300 may include a web based tool for tracking and controlling software changes to ensure compliance to one or more standards and processes. For example, software changes may be controlled via change requests initiated by the web based tool. The web based tool may be referred to herein as verification tool or verification function. Each change request may generally include a general description of the requested change and links to work items. The work items type may include a failure modes and effects analysis (FMEA), safety goal, requirement, test case, coding task, calibration task, defect task, supporting task, and quality audit task.

The verification tool may be a web based platform with a database set up on a server. The bundled applications in one embodiment may include a web interface or configuration management tool, Apache server repository, and Sub Version as the revision control tool. Suitable web interfaces or configuration management tools include Polarion® WebClient for SVN, or other commercially available and open-source tools. Users of the verification tool may access the tool with a user ID and a password to access the tool. A user may be provided a user interface to open a project by selecting a project or opening a new project.

In one example implementation, a wiki page may be provided with at least two user visualizations. A “Home” user assignments page may display work items assigned to the current logged user. A software development page may display the project links to the software process development such as “Planning”, “Requirements”, “Implementation”, “Testing” and “Releases.” A “Software Process and Guidelines” link may be provided in case a consultation is needed.

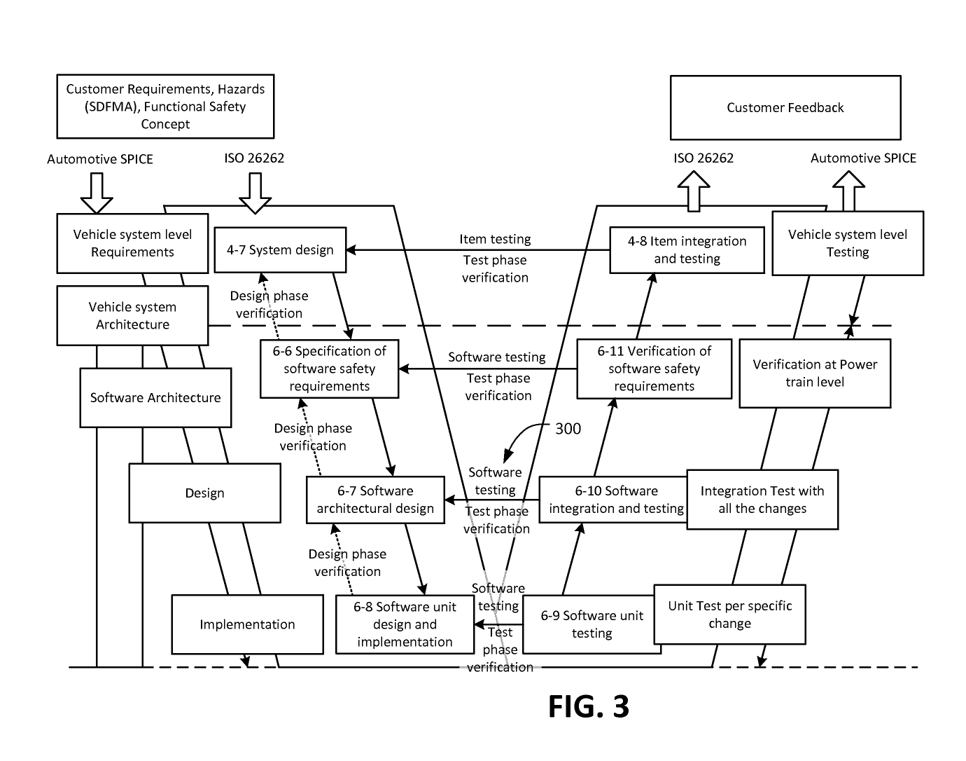

Referring to FIG. 3, in one embodiment the software development process may be a combination of the Automotive SPICE V process, ISO26262 frame work, and Agile Scrum development. Working items such as change requests, FMEA, safety goals, requirements, and test cases may belong to the Automotive SPICE V process and ISO 26262 frame work. Working items such as coding tasks, calibration tasks, defect tasks, and supporting tasks may belong to the Agile Scrum development. In various embodiments, linking between the working items may be used to facilitate development in compliance to the software development processes and standards. In one example embodiment described herein, Automotive SPICE and ISO 26262 are used as standards and Agile Scrum is used as the organizational and developmental methodology to prioritize what needs to be done in each of the software development phases. It should be understood that the aforementioned standards and processes are used to illustrate embodiments of this disclosure, and other standards and processes or combinations thereof may be implemented.

Agile software development is a methodology that is followed to overcome issues associated with traditional waterfall development. In Agile development, an iterative approach is used where the software project is completed in iterative phases. Each iteration delivers an incremental working version of the application. Users continually evaluate each working version/iteration of the product, and provide feedback to the development team which the developers incorporate into subsequent versions of the product. This approach provides the opportunity to account for changing business realities and also minimize large scale project/product-failure risk that can sometimes happen when using the waterfall approach to product development. Agile still uses some of the keys steps associated with waterfall development in each iteration, such as analyze, build, and test.

The Agile methodology is typically used in scenarios where the requirements or details of outcomes are not clear at the outset, business needs are changing rapidly, and/or are continually evolving, where testing the feasibility of an available technology to solve a problem is important, where funds to develop the product may be made available incrementally based on the proven feasibility of the product, where bringing a version of the product to market as soon as possible is more critical than having all of the bells and whistles. Self-organizing teams are typically used.

Scrum is a series of “sprints.” Each sprint can last typically from 2 to 4 weeks. A sprint is a complete mini-software development cycle (analyze, build, and test phase). At the end of each sprint, the customer may receive a working version of the product with new/additional functionality as compared to the previous sprint. The customer/users may test the product and provide feedback to the team.

Steps in a “sprint” (i.e., the single basic unit/cycle of development in Scrum) may include:

STEP 1: Sprint Planning Session
Product Owner informs the Team what is to be included in the Sprint, which may be selected from a Product Backlog.
The Product Backlog may include a list of high level requirements.
The Team may determine what can be committed.
Committed items become the Sprint Backlog and does change during the Sprint.

STEP 2: Sprint
The sprint is the period during which the team works on building the features identified in the Sprint Backlog for the sprint.
Daily or weekly Scrum sessions may be held to review issues/problems/roadblocks/progress/commitments.
A Sprint Burn Down chart may be updated each day to indicate progress/completion of items. The team may review the chart to determine where and how effort should to be expended.
The Sprint ends per the schedule regardless of whether all items/tasks are completed.

STEP 3: Product Release (Or Incremental Release)
A working version of the product is released with the features committed to as part of the Sprint.

STEP 4: Sprint Review Meeting
Completed work is reviewed and not completed versus committed items for the Sprint.
Work is presented to stakeholders as a demo.

STEP 5: Sprint Retrospective
Team members may review the sprint.
What worked well and what needs improvement are noted.
A self-corrective session (lessons learned) is conducted to incorporate process improvements in preparation for the next Sprint.

Working items may have their own life cycle and the transition between steps of the life cycle may be performed by a user role in the verification tool. A change request is a working item that may initiate an individual software development and may require an approval with the role “approver” in the verification tool to initiate the life cycle Approved-->Development-->Testing. Typically a software supervisor or a software lead may be assigned this role, with authorization set up by a verification tool administrator.

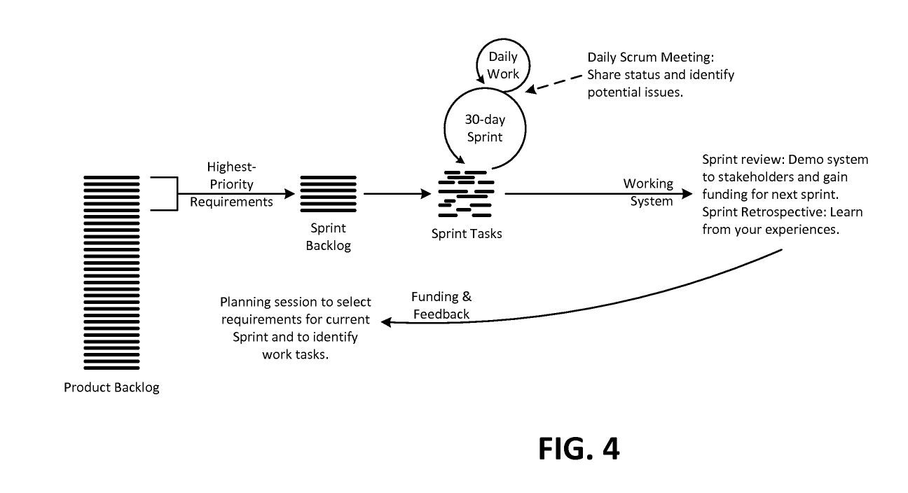

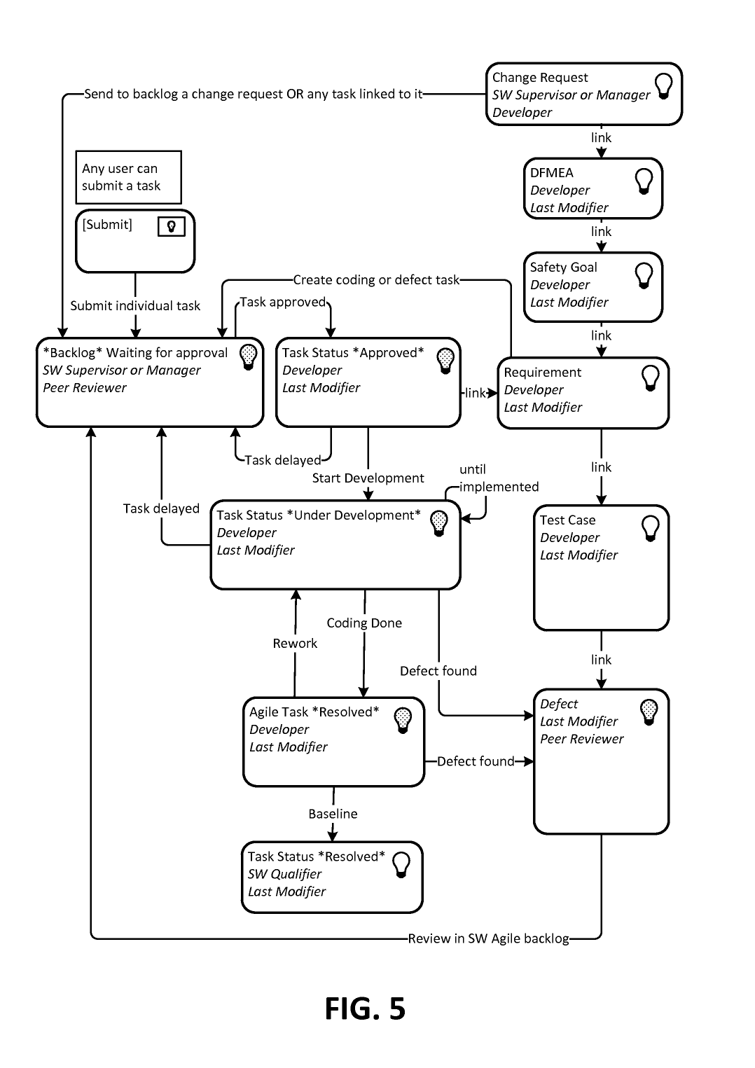

A FMEA working item may be initiated, followed by requirements and related test cases. The coding tasks, calibration tasks, and defect tasks may be created from the change request or from a requirement. A traceability function provided by the verification tool may facilitate tracking of working items and tasks. When a change request is approved, the applicable FMEAs, requirements, test cases, coding tasks, calibration tasks, and defects can also be approved and assigned according to agreements between the team members in the “backlog meeting.” FIG. 4 illustrates an example of a scrum construction life cycle. FIG. 5 illustrates an example of a software development workflow. During a backlog software team meeting, the team may review the work items and define the priority, severity, time point, and the assignee for resolution. The selection of the work items may follow Agile Scrum guidelines, where the highest priority work items are selected from the backlog. The selected items become “iteration work items” to be implemented at a time point (sprint). The subtasks of the change request may be created by the assignee once the work item has been assigned to an individual with role “developer.”

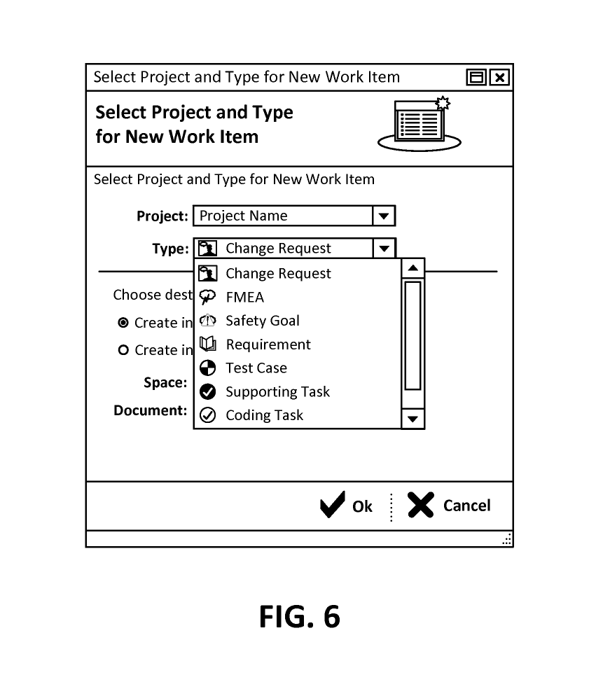

Referring to FIG. 6, an initiator of the change request may create a new working item in the project. The user can create a new work item link in the main wiki page or in the user shortcuts in the left panel. A user with access to the verification tool and to the specific project can be authorized to create a change request work item. A user interface may be provided to display the work item to highlight the fields required in each status. The allowed next status may depend on the individual role setup in the verification tool.

The initiator of a FMEA work item can create a change request by selecting a new work item in the main wiki page or in the user shortcuts, thereby allowing for approvals and transitions with all the work items associated with the FMEA work item. A user with access to the verification tool and to the specific project can create a FMEA work item.

A user may also initiate a safety goal, requirement, or test case and create or link to a change request to allow approvals and planning through a software development process such as Agile Scrum. A safety goal, requirement, or test case work item may also be created.

A user may be designed with the role “approver” and is provided the ability to verify change requests in status “implemented” and change the approval field with the decision taken. Once the software implementation is complete, a user with role “build manager” may proceed to check-in the final software source code to a secured repository. A user with role “quality” may collect traceability data from the working items and, if applicable, from the product software drawings. Once collected and reviewed, a baseline may be created.

A user with role “quality” may create a “quality” work item and perform an analysis audit by collecting data pertaining to risks and process violations, a quality score chart, and a work items trend analysis to generate an assessment of the SPICE Level.

When a software delivery is to be provided to a customer, the individual with role “quality” may review the change requests, tasks, defects, and traceability data from the baseline and release the software with a “Software Delivery Letter” along with executable files at a specified time point to the customer.

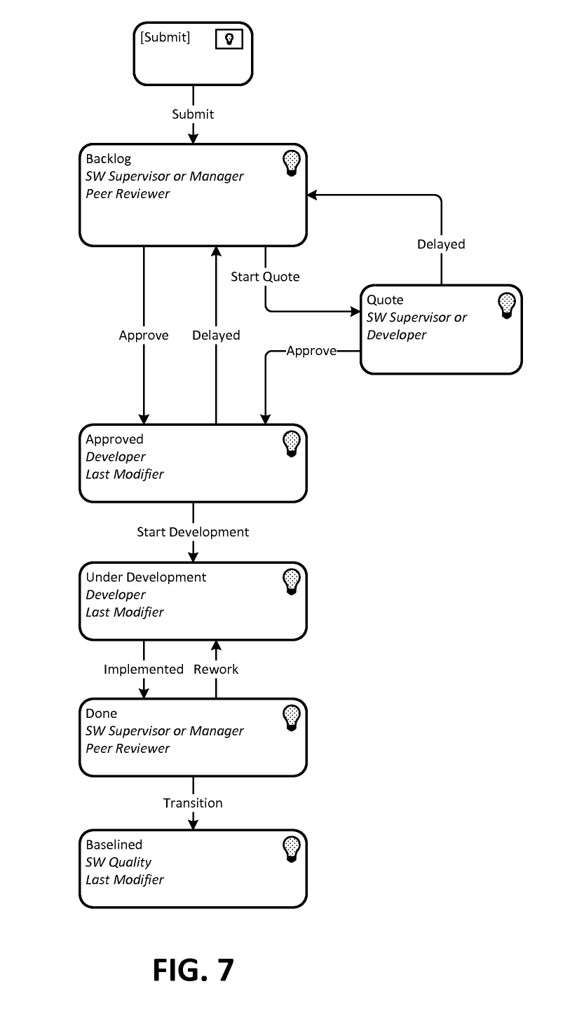

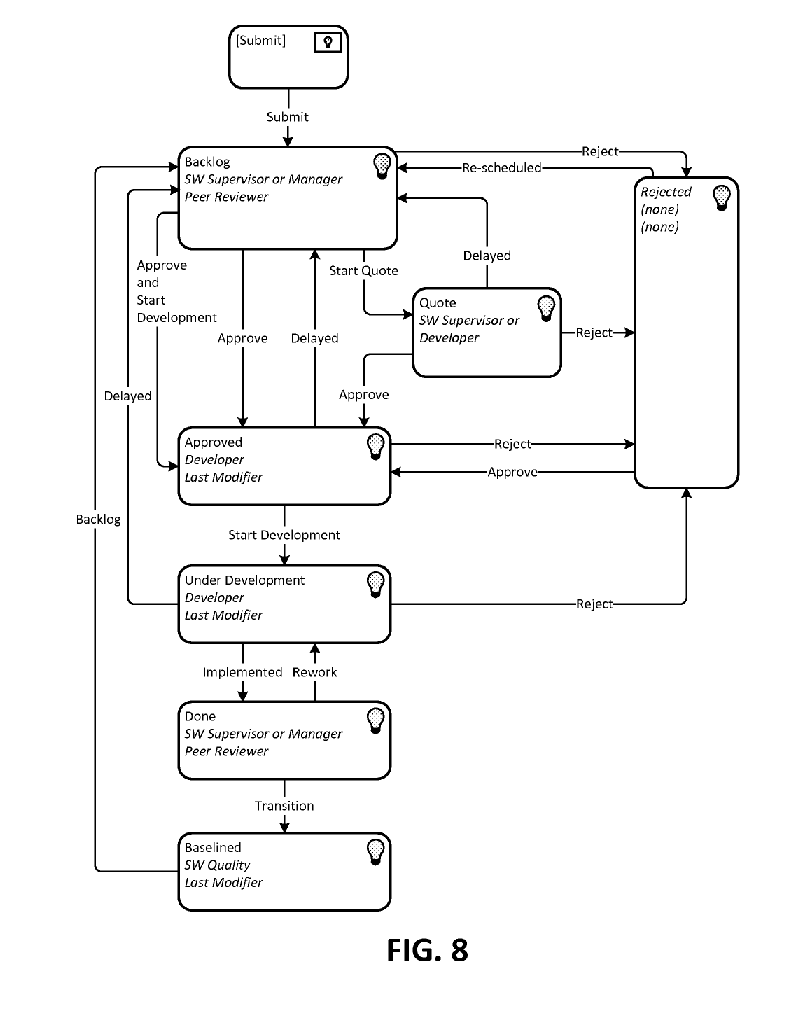

FIG. 7 illustrates an example of a change request workflow for a developer user. FIG. 8 illustrates an example of a change request workflow for a supervisor or approver.

The fields of a working item that is in backlog status can be modified by a user with access to the project in the verification tool. The team members of the backlog meeting may review all the change requests that are in “backlog” status. A user with role “approver” may transition the work item to “approved” status and set the new assignee, time point, and priority. The work item may be placed back into backlog status if the software development for the item has been delayed to sprint iteration.

An assignee may change the status of an item from “approved” to “under development” when the software development begins for that specific work item. The assignee may create links associated with the change request to tasks such as requirements, coding, calibration, and supporting tasks, or link a defect found in a previous software iteration.

In one embodiment, a change request may continue to be in “under development” status until the approved sub working items for the current sprint iteration are completed. When the sub-work items are completed, the current assignee of the change request may transition the status to “Done” and change the assignee to the individual with “approver” role in the verification tool.

An assignee with role “approver” may review the comments of the change request and the sub-work items associated with the change request that are applicable to the current sprint iteration. If satisfied with the implementation the assignee may set the field “approvals” to “approved”. Otherwise the user may set the status to “unapproved,” send back the change request status to “under development,” and set the assignee back to the developer.

A user with role “quality” may review the change requests with status “done” with the approvals field set either to “approved” or “unapproved” to receive or collect information that will be baselined or released to the customer. If the change request indicates “unapproved,” then the reason may be provided in a comments field.

A user with role “quality” may collect all the sub-work items associated with the current sprint, set a baseline in the verification tool, and generate related software delivery documentation.

The change request can be rejected at any time when the status is in backlog, approved, or under development and a decision is made, for example at the backlog meeting. If the rejected work item should be reopened, the item may be placed directly in the backlog to reschedule during either a different sprint iteration than the current iteration or for the current sprint iteration. The sub-work items may be placed back in the backlog until the change request is approved.

A user with role “approver” may send a change request to status “quote” and set the assignee to a user with access to the verification tool. When an item is in the status, software development estimates may be analyzed and the change request may indicate the overall estimate with sub-work items. Once the quote has been accepted either by an internal or external supplier or customer then, the quote can be approved.

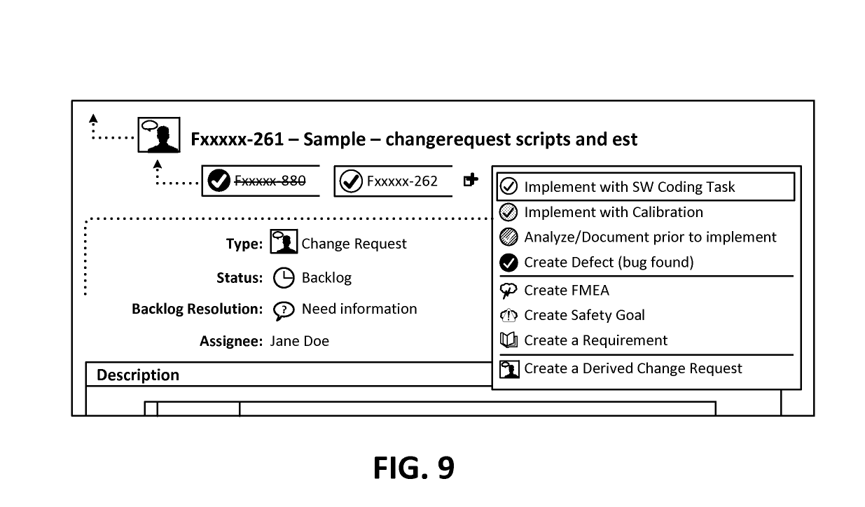

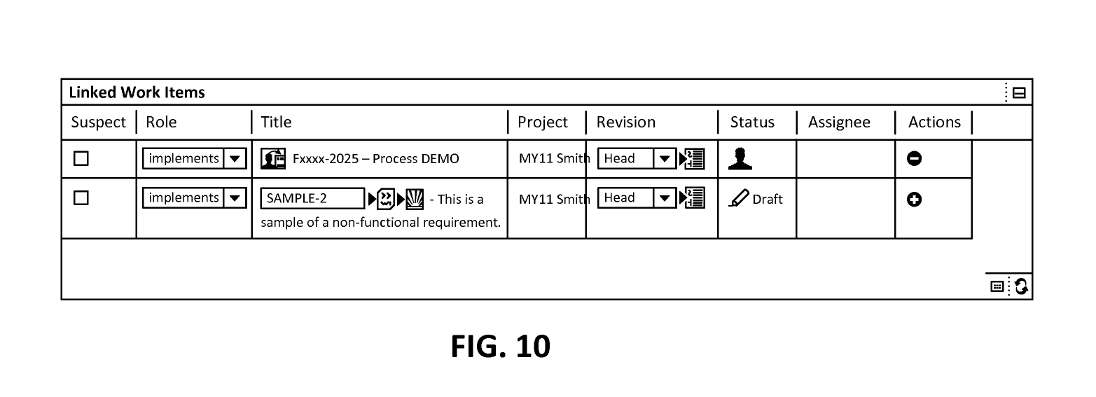

FIG. 9 illustrates an example user interface showing creation of a work item or a sub-work item. FIG. 10 illustrates an example user interface showing manual creation of link associations.

A user with access to the verification tool and to the specific project can create a change request work item and fill the fields requested either in lite or full views. To make the tool easy to use the lite view will request only the required fields according to a status or when it is transitioned to another status.

The tables below provide examples for severity (Table 1), priority (Table 2), and resolution (Table 3) of work items.

TABLE 1

| Name | Description | Sort Order | Default |
|---|---|---|---|
| Must Have | Absolutely required in the | 1 | FALSE |
| | System | | |
| Should Have | Needed in the system | 3 | TRUE |
| Nice to Have | Could be in the system | 5 | FALSE |
| Will not Have | not required | 6 | FALSE |

TABLE 2

| Name | Description | Mini Value | Sort Order | Default |
|---|---|---|---|---|
| Highest | 1st priority | 90 | 1 | FALSE |
| High | 2nd priority | 70 | 2 | FALSE |
| Medium | 3rd priority | 50 | 3 | TRUE |
| Low | 4th priority | 30 | 4 | FALSE |
| Lowest | 5th priority | 10 | 5 | FALSE |

TABLE 3

| Name | Description | Sort Order | Default |
|---|---|---|---|
| Done | The work item is resolved | 1 | FALSE |
| Temporary | Partial implementation | 2 | FALSE |
| Won't do | Not required or the system | 3 | FALSE |
| | can live with it | | |
| Duplicate | Duplicated with another | 4 | FALSE |
| | work item | | |

Table 4 below provides examples showing actions, roles, fields, and transitions.

TABLE 4

| Action | | | |
|---|---|---|---|
| System Variable | Required Roles | Required Fields | Transitions |
| Request | Any | | |
| Init | | | |
| Approve | project_approver | assignee | From: open to: |
| approve | | timePoint | approved |
| | | | From: rejected to: |
| | | | approved |
| | | | From: quote to: |
| | | | approved |
| Start | project-developer | assignee | From: approved to: |
| development | | timePoint | development |
| Start-progress | | initialEstimate | |
| Implemented | | resolution | From: development to: |
| resolve | | | resolved |
| Baseline | project_approver | timePoint | From: resolved to: |
| baseline | | | baselined |
| Rework | project_developer | assignee | From: resolved to: |
| rework | | timePoint | development |
| Delayed or need | project_approver | assignee | From: approved to: |
| Information | | | open |
| Delay | | | From: development to: |
| | | | open |
| | | | From: rejected to: open |
| | | | From: quote to: open |
| Approve and | project_approver | assignee | From: open to: |
| start | | timePoint | Development |
| development | | | |
| quick-rework | | | |
| Reject | project_approver | resolution | From: approved to: |
| reject | | | rejected |
| | | | From: development to: |
| | | | rejected |
| | | | From: open to: rejected |
| | | | From: quote to: rejected |
| Start Quote | project_approver | assignee | From: open to: quote |
| start-quote | | timePoint | |

The FMEA may be a child of the change request. If there is no current change request related to the FMEA, a change request initiator may create a new change request working item. A backlog software team meeting may be conducted to review the work items and define the priority, severity, time point and the assignee for resolution. The selection of the work items may follow the Agile Scrum guidelines (or other guidelines) and select the highest priority work items from the backlog. The selected work items may be indicated as “iteration work items” to be implemented at a time point (sprint). The subtasks of the change request may be created by the assignee once the work item has been assigned to an individual with role “developer.”

The workflow transitions may include role setup in the account of a user in the verification tool. A FMEA work item may be created under the change request. The FMEA work item may include fields to cover the regular columns or information of the FMEA such as causes, occurrence, severity, rate levels, and controls, among others. This work item may be used as an individual FMEA if desired.

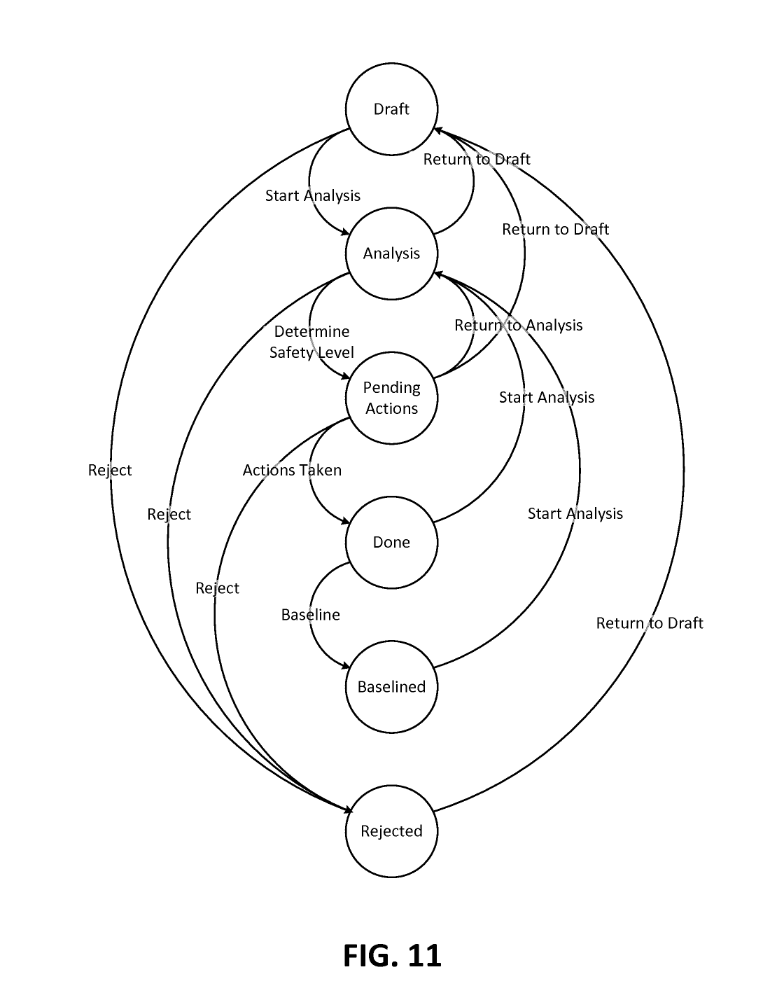

FIG. 11 illustrates an example flow for a work item or a change request.

In one embodiment, the FMEA working items may be set to status “draft” as a default. The “draft” status may be used to gather all the possible failures regardless if the failures are true failures. If not a true failure, then the working item can be rejected or deleted. The fields of the working item in draft status can be modified by a user with access to the project in the verification tool. The author of the FMEA working item may be designated as the assignee by default. The designation can be changed if desired to another user or developer.

In one embodiment, the status can be set to “analysis” by a user with the role “developer” or “approver” to initiate actions based on the causes of failure associated with the risk. The actions may include analysis and collaboration. For example, collaboration can occur via a meeting or electronic means such as email. The comments or the attachments fields in the working item may be used to provide additional information to aid in the analysis.

A new assignee may be changed to a user who will perform the activities defined in the “recommended actions” field and the status may be transitioned to “Pending actions.” The assignee may create links associated with the work item such as safety goals or test cases.

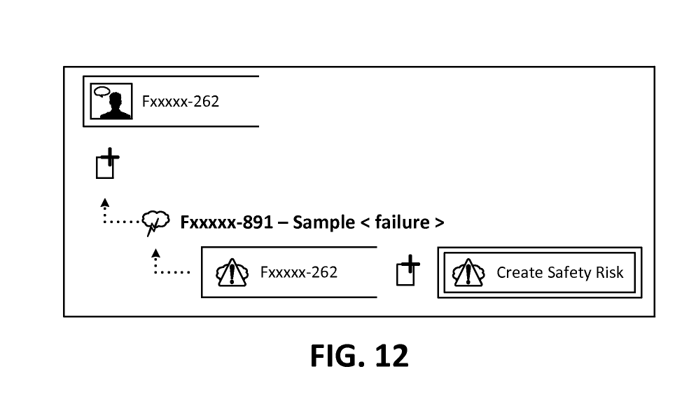

FIG. 12 illustrates an example user interface showing creation of a sub work item. Associated links may be added, and the status may be maintained until associated actions are performed and requirements or safety goals have been completed.

When pending actions and associated sub-working items are completed, the FMEA working item may be transitioned to the status “done” and the assignee field may be changed to the individual with role “approver.” The approver may review the actions taken and associated implementations with sub-work items, and modify the “approvals” field with the decision taken. If the item is unapproved, then the assignee field may be changed to the developer and the status may be set to “analysis.”

A user with role “quality” may review change request with status “done” with the approval field set either to “approved” or “unapproved” to collect the information that will be baselined or released to the customer. If the work item shows “unapproved” then the reason for keep the work item in the current release may be addressed in the comments field.

A user with role “quality” may collect sub-work items associated with the current sprint, set a baseline in the verification tool, and generate the related software delivery documentation. A change request may be rejected when, for example, the status is in backlog, approved, or under development, and a decision to reject is made (e.g., at the backlog meeting). If the rejected work item needs to be reopened, the work item may be placed directly in the backlog to reschedule in a different sprint iteration than the current iteration or the work item may be approved for the current sprint iteration. Sub-work items may be placed back in the backlog until the change request is approved.

FMEA work items may include the custom fields shown in Table 5.

TABLE 5

| Name | | |
|---|---|---|
| System Variable | Description | Type |
| Severity Rating | Failure Severity | integer |
| severityRating | Rating | |
| Occurrence Rating | Cause Occurrence | integer |
| occurrenceRating | Rating | |
| Detection Rating | Control Detection | integer |
| detectionRating | Rating | |
| Risk Priority | Risk Priority Number | integer |
| rpn | | |
| Potential Cause(s) | Potential Cause(s) or | Text (Multi lines) |
| causes | Source of Malfunction | |
| Current Controls | Current Controls | Text (Multi lines) |
| controls | | |
| Characteristic | Characteristic | Text (Multi lines) |
| characteristic | | |
| Recommended Actions | Recommended | Text (Multi lines) |
| recommendedActions | Actions | |
| Taken Actions | Actions Taken | Text (Multi lines) |
| takenActions | | |
| New Occurrence Rating | New Occurrence | integer |
| occurrenceRatingNew | Rating after Actions | |
| New Detection Rating | New Detection Rating | integer |
| detectionRatingNew | after Actions | |
| New Severity Rating | New Severity Rating | integer |
| severityRatingNew | after actions | |
| New Risk Priority | New Risk Priority | integer |
| rpnNew | Number after Actions | |

Actions and transactions may include the following shown in Table 6:

TABLE 6

| Action | | | |
|---|---|---|---|
| System Variable | Required Roles | Required Fields | Transitions |
| Initialization | any | | |
| Start Analysis | any | assignee | From: draft to: |
| Start-analysis | | safetyOperMode | analysis |
| | | safetyFailure | From: resolved to: |
| | | causes | analysis |
| | | | From: baselined to: |
| | | | analysis |
| Determine Safety | any | safetySeverityLvl | From: analysis to: |
| Level | | safetyServerityRationale | action pending |
| Plan-actions | | safetyExposureLvl | |
| | | safetyExposureRationale | |
| | | safetyControlvl | |
| | | safetyControLRationale | |
| | | safetyASIL | |
| | | recommendedActions | |
| Actions Taken | any | resolution | From: action-pending |
| actions-taken | | takenActions | To: resolved |
| | | approvals | |
| Baseline | Project_approver | resolution | From: resolved to: |
| baseline | | timePoint | baselined |
| Return to Draft | project_approver | None | From: action- |
| Return-draft | | | pending to: draft |
| | | | From: analysis to: |
| | | | draft |
| | | | From: rejected to: |
| | | | draft |
| Return to Analysis | project_approver | None | From: action-pending |
| return-analysis | project_admin | | to: analysis |
| Reject | project_approver | resolution | From: analysis to: |
| reject | project-admin | | rejected |
| | | | From: action- |
| | | | pending to: rejected |
| | | | From: draft to: |
| | | | rejected |

A safety goal work item may be included under an FMEA work item. The safety goal work item may contain fields to cover ISO26262 items such ASIL level, exposure, controllability, severity, and rationale taken to determine the safety level. In one embodiment, safety goal working items may be set to the status “draft” as a default. This status may be used to gather the possible safety failures regardless if those are true failures or not. If it is not a true failure, then the working item may be rejected or deleted. The fields of the working item in draft status may be modified by a user with access to the project in the verification tool. The author of the safety goal may be designated as the assignee by default. This designation may be changed if desired to another developer or user.

The work item status can be set to “analysis” by a user with role “developer” or “approver” to initiate analysis of the causes of failure associated with the risk. The analysis can be performed automatically or by collaboration between one or more users (for example by meeting or by email). The comments or the attachments fields in the working item may be used to add additional information to aid the analysis. A new assignee may be changed to the individual who will perform the activities defined in the “recommended actions” field and the status may be transitioned to “Pending actions.” The assignee may create links associated to the work item such as requirements or agile tasks. Links may be added, and the status may be maintained until all the actions are performed and all the requirements or safety goals have been completed. Once the pending actions and associated sub-working items are completed, the safety goal working item may be transitioned to status “done” and the assignee field may be changed to the user with role “approver.” The approver may review the actions taken, the associated implementation with sub-work items, and modify the “approvals” field with the decision taken. If the item is unapproved then the assignee field may be changed back to the developer and the status may be set to “analysis.” The user with role “quality” or “build manager” may reviews the change request in status “done” with the approvals field set either to “approved” or “unapproved” to collect the information that will be baselined or released to the customer. If the work item shows “unapproved” then the reason for keeping the item in the current release may be addressed in the comments field. A user with role “quality” or “build manager” may collect all the sub-work items associated with the current sprint, set a baseline in the verification tool and generate the related software delivery documentation. The change request can be rejected at when the status is in backlog, approved, or under development and a decision is made, for example at the backlog meeting. If the rejected work item needs to be reopened then the item may be placed directly in the backlog to reschedule in a different sprint iteration than the current iteration or the item may be approved for the current sprint iteration.

Safety goal fields may include the following shown in Table 7:

TABLE 7

| Field ID | Description |
|---|---|
| type | Work item type |
| Title | Short description in the title |
| priority | multiple selection: see Table 2 |
| severity | multiple selection: see Table 1 |
| status | multiple selection: see Tables 4, 6, and 9 and |
| | FIG. 11 |
| created | Stamp date of when the work item was created |
| assignee | user assigned to the work item |
| author | user who created the work item |
| plannedStart | Date |
| timePoint | Milestone or Sprint when the baseline will take |
| | place. |
| description | Description in rich text format |
| categories | category or categories applicable to the workitem |
| resolution | multiple selection: see Table 3 |
| previousStatus | multiple selection: see ‘status’ Field ID |
| dueDate | date of when the work item is expected |
| initialEstimate | Estimate in hours or days |
| timeSpent | Hours or days spent |
| remainingEstimate | Hours or days still pending in the development |
| attachments | Files uploaded into the work item |
| updated | Stamp date of when the work item was updated |
| plannedEnd | Date |
| approvals | Users with approval allowance |
| planningConstraints | Date restrictions |
| linkedWorkItems | Link to parent or child work items |
| hyperlinks | Link to external http sites (outside of the tool) |
| linkedRevisions | Source code revision in subVersion tool |
| Comments | Peer review field |

Custom fields may include the following shown in Table 8:

TABLE 8

| Name | | |
|---|---|---|
| System Variable | Description | Type |
| Potential Cause(s) | Potential Cause(s) or | string |
| causes | Source of Malfunction | |
| Recommended Actions | Recommended Actions | string |
| recommendedActions | | |
| Taken Actions | Actions Taken | string |
| takenActions | | |
| Vehicle Operating Mode | Power mode, parking, | string |
| safetyOperMode | driving, neutral, etc. | |
| Failure Effect/Hazard | Hazard caused | string |
| safetyFailure | | |
| Severity(S) Level | S0-S3 Levels of ISO | Enum:severity |
| safetySeverityLvl | 26262 | |
| Severity(S) Rationale | Why the severity was | string |
| safetySeverityRationale | determined | |
| Exposure(E) Level | E0-E4 Levels of ISO | enum:exposure |
| safetyExposureLvl | 26262 | |
| Exposure(E) Rationale | Why the exposure was | string |
| safetyExposureRationale | determined | |
| Controllability(C) Level | C0-C3 Levels of ISO | enum:controllable |
| safetyControlLvl | 26262 | |
| Controllability(C) | How the control level was | string |
| Rationale | determined | |
| safetyControlRationale | | |
| ASIL Rating | ASIL Level per ISO 26262 | Enum:ASIL |
| safetyASIL | | |

Actions and transitions may include the following shown in Table 9:

TABLE 9

| Action | | | |
|---|---|---|---|
| System Variable | Required Roles | Required Fields | Transitions |
| Initialization | Any | None | |
| Init | | | |
| Start Analysis | Any | assignee | From: draft to: |
| start-analysis | | safetyOperMode | analysis |
| | | safetyFailure | From: resolved to: |
| | | causes | Analysis |
| | | | From: baselined to: |
| | | | analysis |
| Determine Safety | Any | safetySeverityLvl | From: analysis to: |
| Level | | safetySeverityRationale | Action-pending |
| plan-actions | | safetyExposureLvl | |
| | | safetyExposureRationale | |
| | | safetyControlLvl | |
| | | safetyControlRationale | |
| | | safetyASIL | |
| | | recommendedActions | |
| Actions Taken | Any | resolution | From: action-pending |
| actions-taken | | takenActions | to: resolved |
| | | approvals | |
| Baseline | project_quality | Resolution | From: resolved to: |
| baseline | project_buildManager | timePoint | baselined |
| Return to Draft | project approver | None | From: action-pending |
| return-draft | | | to: draft |
| | | | From: analysis to: |
| | | | draft |
| | | | From: rejected to: |
| | | | draft |
| Return to Analysis | project approver | None | From: action-ending |
| return-analysis | | | to: analysis |
| Reject | project approver | resolution | From: analysis to: |
| reject | | | rejected |
| | | | From: action-pending |
| | | | to: rejected |
| | | | From: draft to: |
| | | | rejected |

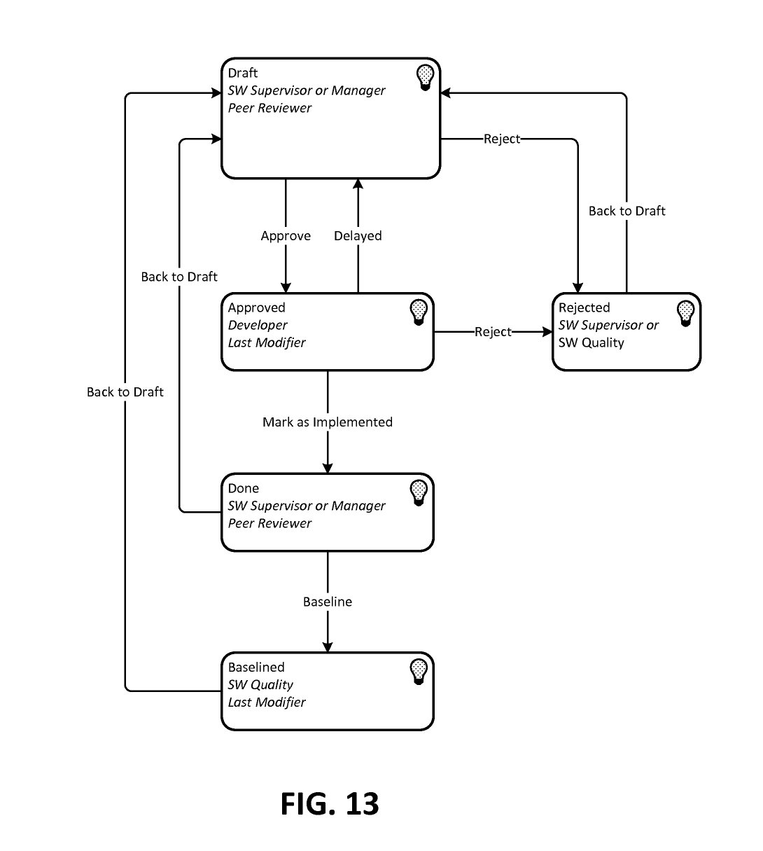

A vehicle requirement may be a child of the change request or a safety goal. The user may search for an existent change request or create a new change request working item in the current project using one of the user interfaces described herein. For example, a user may create a new work item link in the main wiki page or by making a selection under the change request or under safety goal work items. FIG. 13 illustrates an example requirements workflow. In one embodiment the workflow transitions may be limited to the role set up in the account of the user in the verification tool. The requirement work item may be under the change request or the safety goal work items. The requirement work item may further contain fields to cover the type of requirement such as drivability, safety, manufacturing service, or experimental. Requirement working items may be set to the status “draft” as a default. The assignee and time point fields may be inherited from the change request or safety goal. The draft status may be used to describe the requirement or wiki requirements. If it is not a true requirement, then the working item can be unmarked or deleted. The fields of the working item in draft status can be modified by a user with access to the project in the verification tool. The author of the safety goal may be the assignee by default, which can be changed if desired to another user or developer.

A requirement may be created in a Wiki page by writing directly in the desired wiki using the view edit, using for example “rich text.” Links can be created to other wiki pages. The wiki page may include attachments if desired. Additionally and optionally, the wiki page may include scripts. Text may be included in the wiki as reference or commentary. A requirement ID may be displayed in the wiki as an indication of the work item. The new requirement work item may be linked back to a change request to allow processing of approvals and coverage in the software iteration.

The requirement may be transitioned to status “approved” when the parent change request work item is approved by the user with role “approver.” The requirement may be transitioned to status “Done” when the associated coding tasks are completed by the user with role “developer.” The requirement may be placed back to status “draft” for further modifications in the text if required. Typically the time point of a requirement may be inherited from the change request, but the time point may be changed, even when its status is “approved” or “done.” The purpose is to reuse the same requirement in a newer sprint to address a defect or another agile task related to it.

A user with role “quality” or “build manager” may reviews the work items with status “done” to collect the information that will be baselined or released to the customer. If the work item indicates “unapproved” then the reason may be addressed in the comments field. The user with role “quality” or “build manager” may collect all the sub-work items associated with the current sprint, set a baseline in the verification tool, and generate the related software delivery documentation. The work item may be rejected when the status is in backlog, approved or under development, and a decision is reached, for example, at the backlog meeting. If the rejected work item should be reopened then the item may be placed directly in the backlog to reschedule in a different sprint iteration than the current iteration or may be approved for the current sprint iteration. The sub-work items may go back to the backlog until the change request is approved.

Custom fields may include the following in Table 10:

TABLE 10

| Name | | | |
|---|---|---|---|
| System | | | |
| Variable | Required Roles | Type | Allowed values |
| Req. type | Requirement | enum:reqtype | System |
| retype | | | Drivebility |
| | | | Safety Software |
| | | | Safety Hardware |
| | | | ODB II |
| | | | Experimental |

Vehicle requirement fields may include the following shown in Table 11:

TABLE 11

| Field ID | Description |
|---|---|
| type | Work item type |
| title | Short description in the title |
| priority | multiple selection: see Table 2 |
| severity | multiple selection: see Table 1 |
| status | multiple selection: see Tables 4, 6, and 9 and |
| | FIG. 11 |
| created | Stamp date of when the work item was created |
| assignee | user assigned to the work item |
| author | user who created the work item |
| plannedStart | Date |
| timePoint | Milestone or Sprint when the baseline will take |
| | place |
| description | Description in rich text format |
| categories | category or categories applicable to the workitem |
| resolution | multiple selection: see Table 3 |
| previous Status | multiple selection: see ‘status’ Field ID |
| dueDate | date of when the work item is expected |
| initialEstimate | Estimate in hours or days |
| timeSpent | Hours or days spent |
| remainingEstimate | Hours or days still pending in the development |
| attachments | Files uploaded into the work item |
| updated | Stamp date of when the work item was updated |
| plannedEnd | Date |
| approvals | Users with approval allowance |
| planningConstraints | Date restrictions |
| linkedWorkItems | Link to parent or child work items |
| hyperlinks | Link to external http sites (outside of the tool) |
| linkedRevisions | Source code revision in subVersion tool |
| comments | Peer review field |

Actions and transitions may include the following shown in Table 12:

TABLE 12

| Actions | Required Roles | Required Fields | Transitions |
|---|---|---|---|
| Approve | any | linkedWorkitems | From: draft to: |
| reviewed | | | approved |
| Mark as | any | | From: approved to |
| Implemented | | | resolved |
| implemented | | | |
| Delayed, | any | | From: approved to: |
| back to draft | | | draft |
| make-draft | | | From: resolved to: |
| | | | draft |
| | | | From: baselined to: |
| | | | draft |
| | | | From: rejected to: |
| | | | draft |
| Quick | project_approver | | From: draft to: |
| Approve and | | | resolved |
| Implement | | | |
| quick- | | | |
| implement | | | |
| Baseline | sw_quality | timePoint | From: resolved to: |
| baseline | | | baselined |
| Reject | project_approver | resolution | From: draft to: |
| reject | | | rejected |
| | | | From: approved to: |
| | | | rejected |

Test case work items based on software change requests and software baselines may be initiated, processed, and implemented. A test case work item may be created when an initiator of thea safety goal creates a new working item in a project. A backlog software team meeting may review the work items and define the priority, severity, time point, and the assignee for resolution. In one embodiment the selection of the work items may follow the Agile Scrum guidelines where the highest priority work items are selected from the backlog. The selected items are “iteration work items” to be implemented in a time point (sprint). The subtasks below the change request may be created by the assignee once the work item has been assigned to a user role “developer.” It should be understood that development models other than Agile Scrum may be implemented.

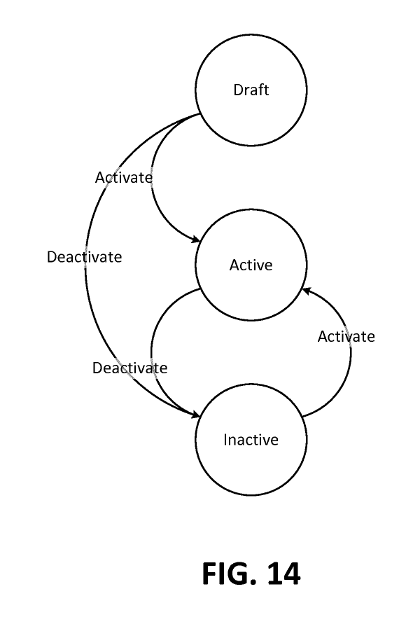

FIG. 14 illustrates an example test case work flow. The test case working items may be set to the status “draft” as a default. This status may be used to create the test case steps and any user assigned to it with role “approver” may transition to active or inactive statuses. The “active” status may be set when a test case has been selected to a specific software iteration (sprint). The table view can be selected to modify the status in bulk. A user or assignee with role “developer” may execute the test and fill the fields “result” and “comments” to stamp the date when the test was executed. The time point field may be used to identify the software package used on that sprint iteration.

When testing is finished, the approver may peer review the final testing, coverage of requirements, coding, and test cases, and modify the field “approvals” with the decision. Inactive status may be selected when the test cases are not scheduled for current software iteration (sprint) and may be reused in future iterations.

A user with role “quality” or “build manager” may review the test cases with status “active” with the approvals field set either to “approved” or “unapproved” to collect the information that will be baselined or released to the customer. If the work item shows “unapproved” then the reason may be addressed in the comments field. A user with role “quality” may collect the sub-work items associated with the current sprint, set a baseline in the verification tool, and generate the related software delivery documentation. The change request may be rejected when the status is in backlog, approved, or under development and the decision, for example, is taken at the backlog meeting. If the rejected work item needs to be reopened then the item may go directly to the backlog to reschedule in a different sprint iteration than the current iteration or the iteration may be approved for the current sprint iteration. The sub-work items may go back to the backlog until the change request is approved.

A test run is a group of test cases used to identify what will be tested per category, release, or special request. A test run is created to query the test cases in active status to be executed in the sprint. In one embodiment this can be done by selecting a “Create Test Run” button in the Testing Wiki page or individually when the test case is executed and a “test run” group is selected. The test cases may be individual entities in the verification tool and thus can be moved to another document or exist in multiple test runs or documents. A test run by category template may be selected to execute test cases for a specific feature. The test run ID may be the release version followed by the feature (category). For example: v378_torque may be used where “v” is the version, “378” is the release number and “torque” is the category. A test tun by severity “regression” emplate may be selected to create a test run with all the individual test cases set with severity of “regression.” This type of test run may be executed when a major change in software is to be released and a number of regression test cases may be selected by setting the status to active or inactive. Templates for test runs by other severity levels for integration, unit, or integration and basic may be provided. A template for a test run for release checkout may be selected to create a test run with a single test case or group of test cases with severity set to “release checkout.” This test run may execute an overall test to confirm the final build prior to release to the customer. The approval of this template may be restricted to a user with role “project_approver.” The test cases may be executed directly in a test run wiki page that may be autogenerated from the templates or individually when the work item table view is used. If the test run is used then the overall results may be displayed along with the test run approvals.

Test run fields may include the following as shown in Table 13:

TABLE 13

| Name | Description | Type |
|---|---|---|
| Test Run | Group of test cases | string |
| testRun | | |
| Test Result | Pass/fail result | enum:testResult |
| testResult | | |
| Test Comment | Brief description of the | String |
| testComment | result | |
| Retest | Execute the test again | Boolean |
| retest | | |
| Test Type | System drivability, | Enum:testType |
| testType | Safety Software, | |
| | Safety Hardware, | |
| | OBD II, Experimental | |
| | or User Acceptance | |
| Test Case ID | Unique identifier | String |
| testCaseID | | |

Test run actions/transitions may include the following:

| Action | | | |
|---|---|---|---|
| System Variable | Required Roles | Required Fields | Transitions |
| Activate | project_approver | testType | From: inactivate |
| activate | | | to: active |
| | | | From: draft |
| | | | to: active |
| Deactivate | project_approver | resolution | From: active |
| deactivate | any | testResult | to: inactive |
| execute | | testComment | From: draft |
| | | | to: inactive |
| | | | To it self |

Test run field IDs may include the following shown in Table 14:

TABLE 14

| Field ID | Description |
|---|---|
| type | Work item type |
| title | Short description in the title |
| priority | multiple selection: see Table 2 |
| severity | multiple selection: see Table 1 |
| status | multiple selection: see Tables 4, 6, and 9 and FIG. |
| | 11 |
| created | Stamp date of when the work item was created |
| assignee | user assigned to the work item |
| author | user who created the work item |
| plannedStart | Date |
| timePoint | Milestone or Sprint when the baseline will take |
| | place |
| description | Description in rich text format |
| categories | category or categories applicable to the workitem |
| resolution | multiple selection: see Table 3 |
| previousStatus | multiple selection: see ‘status’ Field ID |
| dueDate | date of when the work item is expected |
| initialEstimate | Estimate in hours or days |
| timeSpent | Hours or days spent |
| remainingEstimate | Hours or days still pending in the development |
| attachments | Files uploaded into the work item |
| updated | Stamp date of when the work item was updated |
| plannedEnd | Date |
| approvals | Users with approval allowance |
| planningConstraints | Date restrictions |
| linkedWorkItems | Link to parent or child work items |
| hyperlinks | Link to external http sites (outside of the tool) |
| linkedRevisions | Source code revision in subVersion tool |
| comments | Peer review field |

New tasks pertaining to a particular software development standard or process may also be supported. For example, a new agile task may be initiated, processed, and implemented based on a software change request and software baselines.

The initiator of an agile task may create a new working item in the project. The initial status may be set to “backlog” as a default. During the backlog software team meeting, the work items may be reviewed and the priority, severity, time point, and the assignee for resolution may be determined. The selection of the work items may follow Agile Scrum guidelines, where the highest priority work items from the backlog may be selected as “iteration work items” to be implemented at a time point (sprint). The subtasks of the change request may be created by the assignee once the work item has been assigned to an individual with role “developer.”

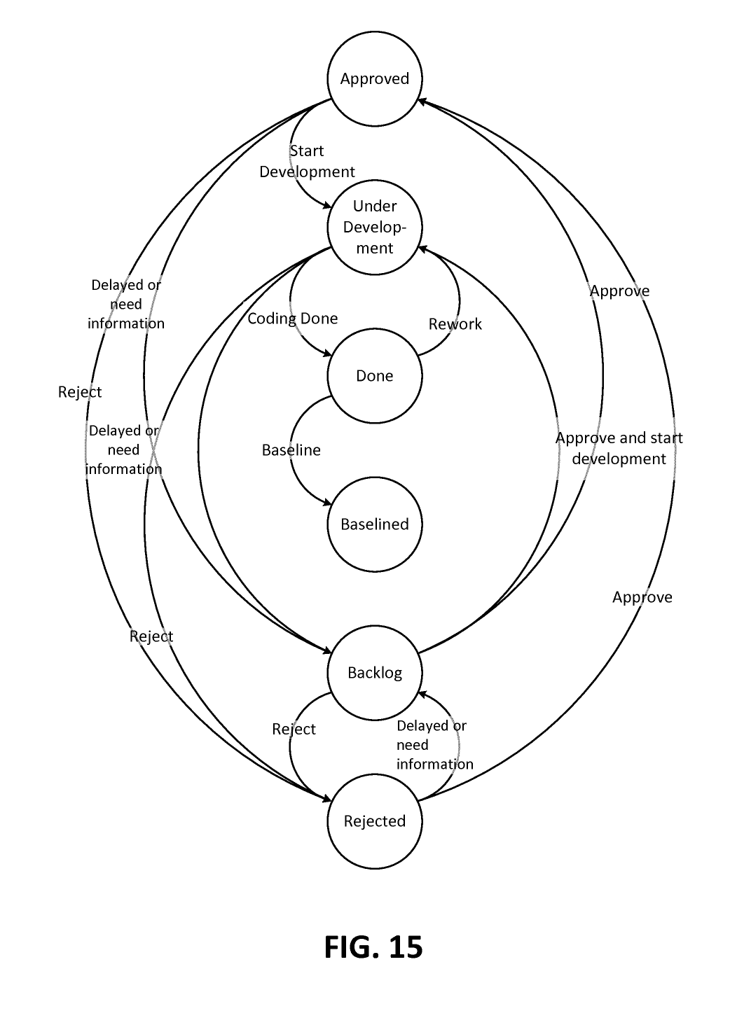

FIG. 15 illustrates an example coding, calibration, defect and supporting task work flow. By default, the tasks working items may be set to the status “backlog.” This status may be used to organize the priorities of the tasks to be reviewed in the backlog meeting. A user assigned to the item with role “developer” may create tasks for the change request work items. Fields of the working item in backlog status can be modified by a user with access to the project in the verification tool. The team members at the backlog meeting may review the change requests in “backlog” status. The user with role “approver” may transition the work item to the “approved” status and set the new assignee, time point, and priority. The work item can return to the backlog status if the software development on that specific item has been delayed to sprint iteration. The status of the agile task may be changed to approved when the parent change request work item is approved by the user with role “approver” or “developer.” In the case of a defect task, the user with role “developer” can authorize the implementation but the impact or timing is typically discussed with the user with role “approver.”

The agile task may remain in “under development” status until the implementation is completed. The coding change may be peer reviewed and the “comments” or “attachments” field in the work item may be used for this purpose. The agile task may be linked to a requirement. If the agile task is a safety related, the task may be linked to an individual test case to ensure testing has been completed for that specific functionality. If the agile task is drivability related then the task may be linked to a group of test cases or to the overall test case for that specific sprint. An assignee with role “approver” may review the comments of the agile task and the parent-work items associated with the task applicable to the current sprint iteration. If satisfied with the implementation, the field “approvals” in the parent change request may be set to “approved,” and otherwise the field may be set to “unapproved.” in which case the change request status may be changed to “under development” and the assignee may be sent to the developer.

A user with role “quality” may review agile tasks and their traceability to the source code. The change requests with status “done” and the approvals field may be set either to “approved” or “unapproved” to collect the information that will be baselined or released to the customer. If the change request indicates “unapproved” then the reason for maintaining in the current release may be addressed in the comments field. A user with role “quality” may collect the work items associated with the current sprint, set a baseline in the verification tool, and generate the related software delivery documentation. The agile task may be rejected when the status is in backlog, approved, or under development and such a decision is made at the backlog meeting. If the rejected work item should be reopened then the item may be returned to the backlog to reschedule at a different sprint iteration, the item may be approved for the current sprint iteration. Agile tasks items may be returned to the backlog until the change request is approved.

Actions and transitions may include the following shown in Table 15:

TABLE 15

| Actions | Required Roles | Required Fields | Transitions |
|---|---|---|---|
| Request | any | timePoint | |
| init | | | |
| Approve | project_approver | assignee | From: open to: |
| approve | | timePoint | approved |
| | | | From: rejected to: |
| | | | approved |
| Start development | Any | assignee | From: approved to: |
| start-development | | timePoint | development |
| | | initialEstimate | |
| Coding done | Any | resolution | From: development to: |
| resolve | | timeSpent | resolved |
| Baseline | Project_approver | timePoint | From: resolved to: |
| baseline | | assignee | Baselined |
| Rework | Any | assignee | From: resolved to: |
| rework | | | development |
| Delayed or need | project_approver | assignee | From: approved to: |
| information | | backlogResolution | open |
| delay | | | From: development to: |
| | | | open |
| | | | From: rejected to: open |
| Approve and start | project_approver | assignee | From: open to: |
| development | | timePoint | development |
| quick-rework | | | |
| Reject | Project_approver | resolution | From: approved to: |
| reject | | | rejected |
| | | | From: development to: |
| | | | rejected |
| | | | From: open to: rejected |

Field IDs may include the following in Table 16:

TABLE 16

| Field ID | Description |
|---|---|
| type | Work item type |
| title | Short description in the title |
| priority | multiple selection: see Table 2 |
| severity | multiple selection: see Table 1 |
| status | multiple selection: see Tables 4, 6, and 9 and FIG. |
| | 11 |
| created | Stamp date of when the work item was created |
| assignee | user assigned to the work item |
| author | user who created the work item |
| plannedStart | Date |
| timePoint | Milestone or Sprint when the baseline will take |
| | place |
| description | Description in rich text format |
| categories | category or categories applicable to the workitem |
| resolution | multiple selection: see Table 3 |
| previousStatus | multiple selection: see ‘status’ Field ID |
| dueDate | date of when the work item is expected |
| initialEstimate | Estimate in hours or days |
| timeSpent | Hours or days spent |
| remainingEstimate | Hours or days still pending in the development |
| attachments | Files uploaded into the work item |
| updated | Stamp date of when the work item was updated |
| plannedEnd | Date |
| approvals | Users with approval allowance |
| planningConstraints | Date restrictions |
| linkedWorkItems | Link to parent or child work items |
| hyperlinks | Link to external http sites (outside of the tool) |
| linkedRevisions | Source code revision in subVersion tool |
| comments | Peer review field |

In some embodiments, a software quality tool may be provided that may be implemented as a web based platform with a database and set up on a server. The bundled applications with the tool may include a web interface or configuration management tool, Apache server repository and Sub Version as the revision control tool.

In one embodiment the roles may include the following shown in Table 17:

TABLE 17

| Role Name | Description |
|---|---|
| project_user | User is granted limited access to the project. User can read all |
| | Objects but not modify or create them. User can download builds |
| | and view reports, but cannot initiate builds or refresh reports. |
| project_admin | User granted access to Administration for the project in which the |
| | role is assigned. User has full administrator permissions within the |
| | scope of the project. User cannot access Administration in other |
| | projects where this role is not assigned him/her. User cannot access |
| | Repository Administration unless granted the role admin in that |
| | scope. Note that a user assigned that permission does not need to |
| | have the project_admin role assigned in any project. |
| project_developer | User is granted read/write access (excluding Administration) to the |
| | project in which the role is assigned. User can read, create and |
| | modify all objects, run and browse reports and builds. User cannot |
| | be assigned Work Items unless role project_assignable is also |
| | assigned. |
| project_assignable | Project-scope permission to have Work Items assigned. |
| project_quality | Project-scope permission to generate all the documentation, scripts |
| | and build automated audits. |
| project_approver | Project-scope permission to approve/disapprove Work Items. Users |
| | assigned to this role for a project appear in the list of approvers in |
| | the Approvals section of the project's Work Items (Work Items |
| | topic, Table view; Document, Table View). That list also includes |
| | users who are assigned the global approver role. (If no users are |
| | assigned this role for the project, then only those users assigned the |
| | global approver role appear in the Approvers list in project Work |
| | Items.) |

The software quality tool may use project templates to create new projects. The templates may contain dedicated workflows, system variables, scripts, wiki pages, roles, work items, quality monitoring charts as part of a specific process. For example, a template that incorporates the Capability Maturity Model (CMM), Automotive SPICE, ISO 26262, and Agile Scrum may be generated.

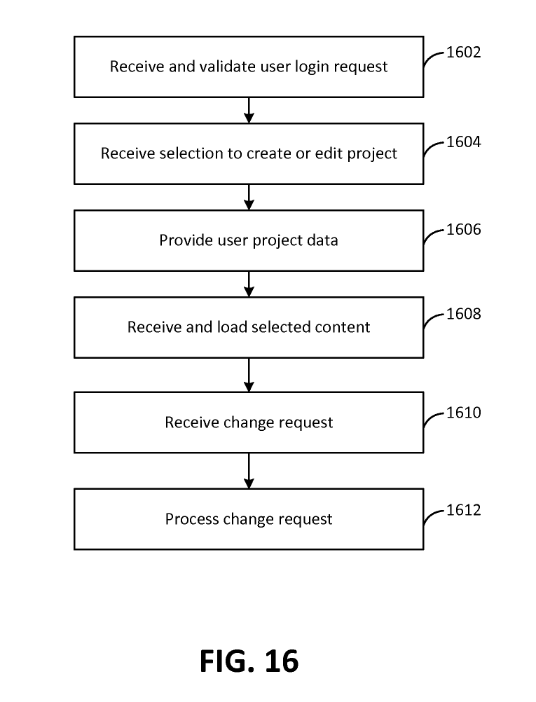

FIG. 16 is a flowchart depicting an example of a method for providing a software development environment. As seen at 1602, the method may begin when a user, such as a developer, logs into an application development environment, such as that illustrated in FIGS. 1 and 2. In response to validating the user's login credentials, a user may select an option to create a new project, as illustrated at 1604. The user may also be presented with options to edit or view an existing project.

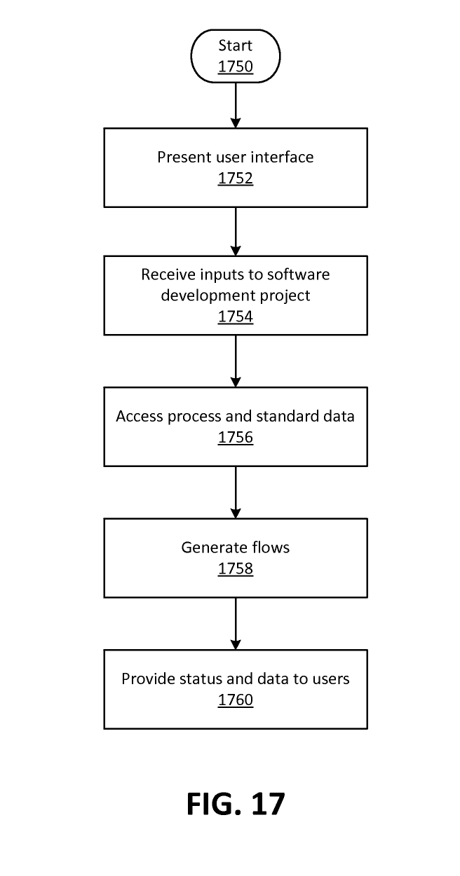

FIG. 17 illustrates an example of an operational procedure for developing and deploying software applications. In one embodiment, the operational procedure may be implemented in a computing environment hosted by a multi-user computing services platform.

In some embodiments, a system may be implemented. The system may be configured to develop and deploy software applications in a computing environment hosted by a multi-user web services platform. The system may comprise a memory storing computer instructions that, when executed by one or more processors of the system, cause the system to implement functions such as a developer editor and a development environment.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a smart phone, a cellular telephone, a tablet, a web-book, a notebook computer, a desktop computer, a workstation computer, a server, a cloud, or the like, or an array of processors, microprocessors, central processing units, general purpose computers, super computers, personal computers, laptop computers, palmtop computers, notebook computers, desktop computers, workstation computers, servers, or the like.

A “network,” as used in this disclosure, means any combination of software and/or hardware, including any machine, device, circuit, component, or module, or any system of machines, devices, circuits, components, modules, or the like, which are capable of transporting signals from one location to another location, where the signals may comprise information, instructions, data, and the like. A network may include, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), or the like, any of which may be configured to communicate data via a wireless and/or a wired communication medium.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, Wi-Fi, Wi-MAX, IEEE 802.11, DECT, OG, 1G, 2G, 3G, or 4G cellular standards, Bluetooth®, and the like. One or more communication links may be used in an environment 100 (shown in FIG. 1) to allow sufficient data throughput and interaction between end-users (such as, e.g., agents, consumers, insurance carriers, estate planners, financial providers, web host providers, and the like). Techniques for implementing such communications links are known to those of ordinary skilled in the art.

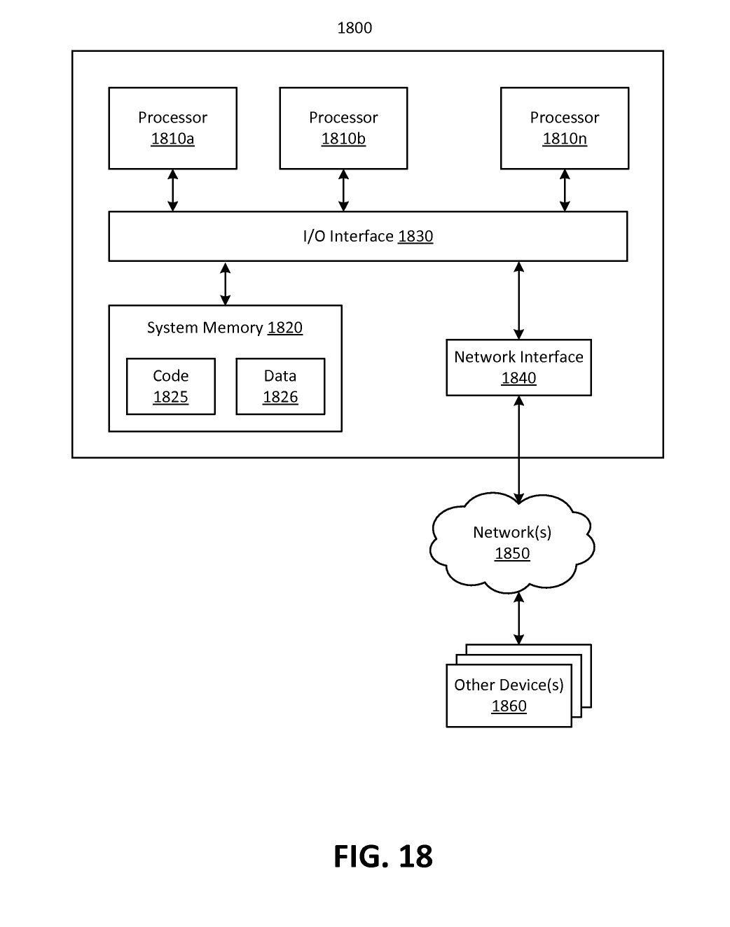

In at least some embodiments, a computer that implements a portion or all of one or more of the technologies described herein may include a general purpose computer system that includes or is configured to access one or more computer-accessible media. FIG. 18 illustrates such a general purpose computing device 1800. In the illustrated embodiment, computing device 1800 includes one or more processors 1810a, 1810b, and/or 1810n (which may be referred herein singularly as “a processor 1810” or in the plural as “the processors 1810”) coupled to a system memory 1820 via an input/output (I/O) interface 1830. Computing device 1800 further includes a network interface 1840 coupled to I/O interface 1830.

In various embodiments, computing device 1800 may be a uniprocessor system including one processor 1810 or a multiprocessor system including several processors 1810 (e.g., two, four, eight or another suitable number). Processors 1810 may be any suitable processors capable of executing instructions. For example, in various embodiments, processors 1810 may be general purpose or embedded processors implementing any of a variety of instruction set architectures (ISAs), such as the x86, PowerPC, SPARC, or MIPS ISAs or any other suitable ISA. In multiprocessor systems, each of processors 1810 may commonly, but not necessarily, implement the same ISA.

System memory 1820 may be configured to store instructions and data accessible by processor(s) 1810. In various embodiments, system memory 1820 may be implemented using any suitable memory technology, such as static random access memory (SRAM), synchronous dynamic RAM (SDRAM), nonvolatile/Flash-type memory or any other type of memory. In the illustrated embodiment, program instructions and data implementing one or more desired functions, such as those methods, techniques and data described above, are shown stored within system memory 1820 as code 1825 and data 1826.

In one embodiment, I/O interface 1830 may be configured to coordinate I/O traffic between processor 1810, system memory 1820 and any peripheral devices in the device, including network interface 1840 or other peripheral interfaces. In some embodiments, I/O interface 1830 may perform any necessary protocol, timing or other data transformations to convert data signals from one component (e.g., system memory 1820) into a format suitable for use by another component (e.g., processor 1810). In some embodiments, I/O interface 1830 may include support for devices attached through various types of peripheral buses, such as a variant of the Peripheral Component Interconnect (PCI) bus standard or the Universal Serial Bus (USB) standard, for example. In some embodiments, the function of I/O interface 1830 may be split into two or more separate components, such as a north bridge and a south bridge, for example. Also, in some embodiments some or all of the functionality of I/O interface 1830, such as an interface to system memory 1820, may be incorporated directly into processor 1810.

Network interface 1840 may be configured to allow data to be exchanged between computing device 1800 and other device or devices 1860 attached to a network or networks 1850, such as other computer systems or devices as illustrated in FIGS. 1 through 18, for example. In various embodiments, network interface 1840 may support communication via any suitable wired or wireless general data networks, such as types of Ethernet networks, for example. Additionally, network interface 1840 may support communication via telecommunications/telephony networks such as analog voice networks or digital fiber communications networks, via storage area networks, such as Fibre Channel SANs, or via any other suitable type of network and/or protocol.

In some embodiments, system memory 1820 may be one embodiment of a computer-accessible medium configured to store program instructions and data as described above for FIGS. 1-10 for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media, such as magnetic or optical media, e.g., disk or DVD/CD coupled to computing device 1800 via I/O interface 1830. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 1800 as system memory 1820 or another type of memory. Further, a computer-accessible medium may include transmission media or signals such as electrical, electromagnetic or digital signals, conveyed via a communication medium such as a network and/or a wireless link, such as may be implemented via network interface 1840. Portions or all of multiple computing devices, such as those illustrated in FIG. 18, may be used to implement the described functionality in various embodiments; for example, software components running on a variety of different devices and servers may collaborate to provide the functionality. In some embodiments, portions of the described functionality may be implemented using storage devices, network devices or special purpose computer systems, in addition to or instead of being implemented using general purpose computer systems. The term “computing device,” as used herein, refers to at least all these types of devices and is not limited to these types of devices.

A network set up by an entity, such as a company or a public sector organization, to provide one or more services (such as various types of cloud-based computing or storage) accessible via the Internet and/or other networks to a distributed set of clients may be termed a provider network. Such a provider network may include numerous data centers hosting various resource pools, such as collections of physical and/or virtualized computer servers, storage devices, networking equipment and the like, needed to implement and distribute the infrastructure and services offered by the provider network. The resources may in some embodiments be offered to clients in units called instances, such as virtual or physical computing instances or storage instances. A virtual computing instance may, for example, comprise one or more servers with a specified computational capacity (which may be specified by indicating the type and number of CPUs, the main memory size, and so on) and a specified software stack (e.g., a particular version of an operating system, which may in turn run on top of a hypervisor).

A number of different types of computing devices may be used singly or in combination to implement the resources of the provider network in different embodiments, including general purpose or special purpose computer servers, storage devices, network devices and the like. In some embodiments a client or user may be provided direct access to a resource instance, e.g., by giving a user an administrator login and password. In other embodiments the provider network operator may allow clients to specify execution requirements for specified client applications and schedule execution of the applications on behalf of the client on execution platforms (such as application server instances, Java™ virtual machines (JVMs), general purpose or special purpose operating systems, platforms that support various interpreted or compiled programming languages such as Ruby, Perl, Python, C, C++, and the like, or high-performance computing platforms) suitable for the applications, without, for example, requiring the client to access an instance or an execution platform directly. A given execution platform may utilize one or more resource instances in some implementations; in other implementations multiple execution platforms may be mapped to a single resource instance.

The terms “including,” “comprising,” “having,” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer-readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, Wi-Fi, Wi-MAX, IEEE 802.11, DECT, OG, IG, 2G, 3G, or 4G cellular standards, Bluetooth®, or the like.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

1. A computer-implemented method for developing and deploying software applications comprising:
presenting, to a developer user of a multi-user computing platform, a user interface providing one or more options for accessing a software development project hosted by the multi-user computing services platform;
receiving, by the multi-user computing services platform via the user interface, inputs to the software development project, wherein the inputs comprise at least one of a change request and a work item;
in response to receiving the inputs, accessing data associated with at least one industry standard and at least one software development process;
automatically generating, based on the data, one or more user actions consistent with conformance to the at least one industry standard and at least one software development process; and
providing, by the multi-user computing services platform, a user interface indicative of the one or more user actions.

2. The method of claim 1, wherein the at least one industry standard comprises one or more of ISO 26262, ISO/IEC 15504, and Automotive SPICE.

3. The method of claim 1, wherein the at least one software development process comprises one or more of Agile Scrum and the Capability Maturity Model.

4. The method of claim 1, wherein the one or more user actions comprises one or more of request, approve, baseline, start development, rework, and reject.

5. A system configured to develop and deploy software applications hosted by a multi-user computing services platform comprising
at least one memory having stored therein computer instructions that, upon execution by one or more processors of the system, cause the system to:
present, to a developer user of a multi-user computing platform, a user interface providing one or more options for accessing a software development project hosted by the multi-user computing services platform;
receive, by the multi-user computing services platform via the user interface, inputs to the software development project, wherein the inputs comprise at least one of a change request and a work item;
in response to receiving the inputs, access data associated with at least one industry standard and at least one software development process;
automatically generate, based on the data, one or more user actions consistent with conformance to the at least one industry standard and at least one software development process; and
provide, by the multi-user computing services platform, a user interface indicative of the one or more user actions.

6. The system of claim 5, wherein the at least one memory further comprises computer instructions that, upon execution by one or more processors of the system, cause the system to implement a developer editor configured to present a web-based user interface and a development environment.

7. The system of claim 5, wherein the at least one industry standard comprises one or more of ISO 26262, ISO/IEC 15504, and Automotive SPICE.

8. The system of claim 5, wherein the at least one software development process comprises one or more of Agile Scrum and the Capability Maturity Model.

9. The system of claim 5, wherein the one or more user actions comprises one or more of request, approve, baseline, start development, rework, and reject.
